(19) United States
(12) Patent Application Publication
(10) Pub. No.: US 2024/0199141 A1
(43) Pub. Date: Jun. 20, 2024

(54) Vehicle body component

(71) Applicant: Mubea Carbo Tech GmbH, Salzburg (AT)

(72) Inventors: Christoph Renner, Gosau (AT); Marc Linus Fecher, Laufen (DE)

(73) Assignee: Mubea Carbo Tech GmbH, Salzburg (AT)

(21) Appl. No.: 18/554,598

(22) PCT Filed: Jun. 1, 2022
(86) PCT No.: PCT/EP2022/064949

§ 371 Date: Oct. 9, 2023

(30) Foreign Application Priority Data
Jun. 4, 2021 (DE) 102021114432.9

(51) Int. Cl. B62D 29/04; B32B 1/00; B32B 3/30; B32B 21/13; B32B 21/14; B62D 25/06; B62D 25/10

(52) U.S. Cl. CPC B62D 29/04; B32B 1/00; B32B 3/30; B32B 21/13; B32B 21/14; B62D 25/06; B62D 25/10; B32B 2262/067; B32B 2262/101; B32B 2262/106; B32B 2605/00

(57) ABSTRACT

The present disclosure relates to a vehicle body component including a top sheet, a bottom sheet and a there between arranged core mechanically interconnecting the top sheet and the bottom sheet. Thereby, the top sheet and/or the bottom sheet and/or the core include at least one layer of natural fibrous material having a thickness. The at least one layer of natural fibrous material includes further in a first face at least one first notch extending in a first direction said first notch having a first depth which is less than the thickness of the at least one layer of natural fibrous material.

### CROSS-REFERENCE TO RELATED APPLICATIONS

This application is a U.S. National Stage Application that claims the benefit of the filing date of International PCT Application No. PCT/EP2022/064949, filed on Jun. 1, 2022, that in turn claims priority to German Application No. 102021114432.9, filed on Jun. 4, 2021, that are hereby incorporated by reference in their entirety.

### TECHNICAL FIELD

The present disclosure relates to a vehicle body component.

### BACKGROUND

In the last couple of years, the awareness of the need of sustainable materials for lightweight construction increased continuously. Automotive manufacturers in particular are on an intensive search for new sustainable materials to improve the CO2 balance of their vehicles. It is estimated, that if 1% of steel-based components were replaced with wood-based components, around 140,000 t of greenhouse gases, measured in CO2 equivalents, could be saved globally per year. Sustainable materials as a natural resource have the further benefits that they can be harvested in large quantities and are easily recycled. However, the sustainable materials also need to fulfill the mechanical requirements of the automotive industry.

Wood or other natural fibrous materials have long since proven to have excellent material properties, while having a low density advantageous for lightweight constructions. Furthermore, wood has suitable reversibly deformable properties as e.g. needed to dissipate crash energy. By using natural fiber composites, a valuable contribution to cost and weight reduction as well as to the carbon footprint can be achieved. This is also due to the fact, that the production of e.g. wood-based components requires only a fraction of the energy needed to manufacture aluminum, plastic or steel components.

However, the application of wood for structural, resource-efficient and sustainable components within the vehicle body is combined with many challenges and demands. In the past the automotive industry has focused mainly on processing metal materials allowing a very specific design of the vehicle bodies while fulfilling the structural requirements. In order to use wooden parts in a similar manner, the process chains need to be fundamentally adapted and changed. Furthermore, specific requirements for corrosion such as media and temperature stability need to be taken into account when implementing wood structures into car-bodies.

### SUMMARY

The present disclosure relates to a vehicle body component comprising natural fibrous material. The vehicle body component can e.g. be a roof element or an engine hood of the vehicle. The natural fibrous material can be of cellulosic type such as cotton, wood, flax, etc. The natural fibrous material can thereby be formed by loose fibers which are pressed and glued together or by structurally embedded fibers. An example for loose fibers are coconut fibers. An example for structurally embedded fibers is a wood having wood fibers. A further example for structurally embedded fibers is a fabric of natural fibers. To meet the requirements necessary for vehicles, for example in terms of load-bearing capacity or durability, the natural fibrous material is preferably used in a composite structure, combining e.g. adhesives, plastics, metals or other renewable raw materials with the fibrous material. The composite structure can be layered. In a preferred variation such a comprise structure comprises a top sheet, a bottom sheet and a core interconnecting the top sheet and the bottom sheet.

In the present disclosure the vehicle body component comprises a top sheet, a bottom sheet and a there between arranged core mechanically interconnecting the top sheet and the bottom sheet. Hereby the top sheet and/or the bottom sheet and/or the core can comprise at least one layer of natural fibrous material. Depending on the application it can be advantageous that at least the core comprises at least one layer of natural fibrous material. In other applications, alternatively or in addition, the top sheet and/or the bottom sheet can comprise at least one layer of natural fibrous material. The top sheet comprising the at least one layer of natural fibrous material is advantageous for applications, where the top layer is visible from the outside. Therefore, the at least one layer of natural fibrous material of the top layer can be formed of wooden veneer (e.g. made of poplar, birch or beech wood). This is due to the fact that the wooden veneer has a good optical appearance. A wooden veneer can be understood as a sheet of wood separated from the log by various sawing and cutting processes. The wooden veneer can have a thickness from is 0.5 to 8 mm. If the at least one layer of natural fibrous material is arranged in the core, all kinds of fibrous materials (e.g. also wooden veneer) can be used. It is understood that the top sheet and/or the bottom sheet and/or the core may each comprise multiple layers. Only a fraction of these layers can be made of the natural fibrous material.

In order to improve the mechanical properties as well as the formability of the vehicle body component, the at least one layer of natural fibrous material comprises at least one first notch extending in a first direction from a first face of the at least one layer of natural fibrous material, wherein said first notch has a first depth which is less than a thickness of the at least one layer of natural fibrous material. The first notch can be filled with a filler material improving the mechanical properties of the vehicle body component. The filler may e.g. be an adhesive and/or resin. If multiple notches are present, the filler thus forms a matrix through the at least one layer of natural fibrous material. The matrix can improve the mechanical behavior during and after production of the vehicle body component.

The first notch is further advantageous for applications, where the vehicle body component comprises a curved section. Vehicle body components, such as roof elements or engine hoods, have to meet specific geometric requirements, since the car body parts are often curved in a specific manner. Thus, the vehicle body component is often curved around at least one spatial direction, if not two spatial directions. In the context of this application “curved around a direction” is understood, that the curvature is defined in a plane perpendicular to that direction. (For e.g. a two dimensional circle drawn in a plane, the circle is curved around a spatial direction perpendicular to the plane of said circle.) For the present application the curved section preferably curves around the first direction of the at least one first notch. Preferably, at least one first notch is thereby arranged in said curved section. Thus a cross-section of the at least one first notch can be at least partially reduced or extended due to a curvature of the curved section. If the first face of the layer of natural fibrous material is the convex side of the layer of natural fibrous material, the cross-section of a respective notch is at least partially extended. If the first face of the layer of natural fibrous material is the concave side of the layer of natural fibrous material, the cross-section of a respective notch is at least partially reduced. In case of a reduction of the cross-section, the cross section can also be reduced to zero, such that the notch is folded in itself in a curved state of the layer of natural fibrous material. The at least one layer of natural fibrous material may also comprise multiple first notches extending parallel with respect to each other arranged in the curved section. This is advantageous in particular for small radii, respectively curved section having a higher curvature. Alternatively, or additionally a density of the multiple first notches can correlate to the curvature of the curved section, such that more first notches are arranged in an area with a higher curvature. However, also variations are possible where multiple evenly spaced (first) notches are present, wherein only the notches in the curved section have a reduced or extended cross section due to the curvature of said curved section. The higher the local curvature, the more reduced or extended is the cross section of the respective notches placed in an area of the higher curvature.

Depending on the application, at least one layer of natural fibrous material can comprise at least one second notch having a second depth. Preferably the second notch is arranged in a second face opposite to the first face of the at least one layer of natural fibrous material. The at least one second notch may thereby extend in the first or a second direction, perpendicular to the first direction.

Depending on the application, the at least one first notch and the at least one second notch can intersect each other. Therefore, the first depth and the second depth can be configured such that at least one opening extending through the at least one layer of natural fibrous material at the intersection is formed. This is achieved when the first depth and the second depth are together larger than the thickness of the at least one layer of natural fibrous material. Preferably, the first depth and/or second depth are however at least 60%, in particular 80%, of the thickness of the at least one layer of natural fibrous material.

If the at least one layer of natural fibrous material is made of wood, a general fiber direction can be associated with the layer of natural fibrous material. The general fiber direction is usually aligned with the axis of the trunk, limb, or root of the tree from which the wood originates. This is due to the fact that as the tree grows, most of the wood cells, composed of long, thin bundles of fibers, align themselves with said axis. For the further processing of the layer of natural fibrous material it is advantageous, if the general fiber direction is arranged in the first direction of the at least one first notch.

For the application on vehicles, such as automobiles, the vehicle body component can further comprise a frame for interconnecting the vehicle body component to a vehicle chassis. The frame may thereby be interconnected, in particular glued, to the composite structure, in particular the bottom sheet. The frame is preferably made of metal. The frame can extend along an outer edge of the composite structure, in particular along an outer edge of the bottom sheet.

In one possible variation, at least one layer of natural fibrous material, preferably at least two layers of fibrous material, are arranged in the core of the vehicle body component. The first face can be arranged facing towards the bottom sheet or towards the top sheet. Especially for a vehicle body component having a curved section, it may be advantageous that the core comprise at least two layers of fibrous material glued together in a curved manner. In that case the first faces of the respective layers of fibrous material can face in the same direction or in different directions. To achieve a good deformability, the at least two layers of fibrous material may each have at least one first notch and/or at least one second notch, such that a three dimensional matrix of notches is formed through the core. The three dimensional matrix of notches can form one or more intercommunicating systems of notches. The notches can thereby be filled with the filler (such as resin) through the at least one intercommunicating system of notches.

Depending on the application and the desired optical appearance, the top sheet and/or the bottom sheet can be made of reinforcing fibers (such as e.g. glass or carbon fibers) or other materials. The top sheet and/or the bottom sheet may thus comprise one or multiple layers of reinforcing fibers. Alternatively or additionally, the top sheet and/or the bottom sheet can also comprise at least one layer of natural fibrous material. An outer layer of the top sheet can e.g. be a wooden veneer. The first face, respectively the at least on first notch is thereby preferably arranged towards the bottom sheet, such that the notches are not visible from the outside.

To achieve a three dimensional curved vehicle body component, the layer of natural fibrous material may further have a wedge shaped cutout from an outer edge into the at least one layer of natural fibrous material in the second direction in a non-curved state. The wedge shaped cutout comprises a first and thereto opposite second wedge surface configured to be interconnected with each other in order to form a curvature visible in view from the second direction.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described invention will be more fully understood from the detailed description given herein below and the accompanying drawings which should not be considered limiting to the invention described in the appended claims. The drawings are showing:

FIG. 1 A first variation of a layer of natural fibrous material in a non-curved state;

FIG. 2 The layer of natural fibrous material according to FIG. 1 in a curved state;

FIG. 3 A second variation of a layer of natural fibrous material in non-curved state;

FIG. 4 A cross-section of the layer of natural fibrous material according to FIG. 3;

FIG. 5 Examples of various cross-sections of the layer of natural fibrous material;

FIG. 6 A variation of two layers of natural fibrous material;

FIG. 7 A generic vehicle body component;

FIG. 8 A first variation of a vehicle body component.

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

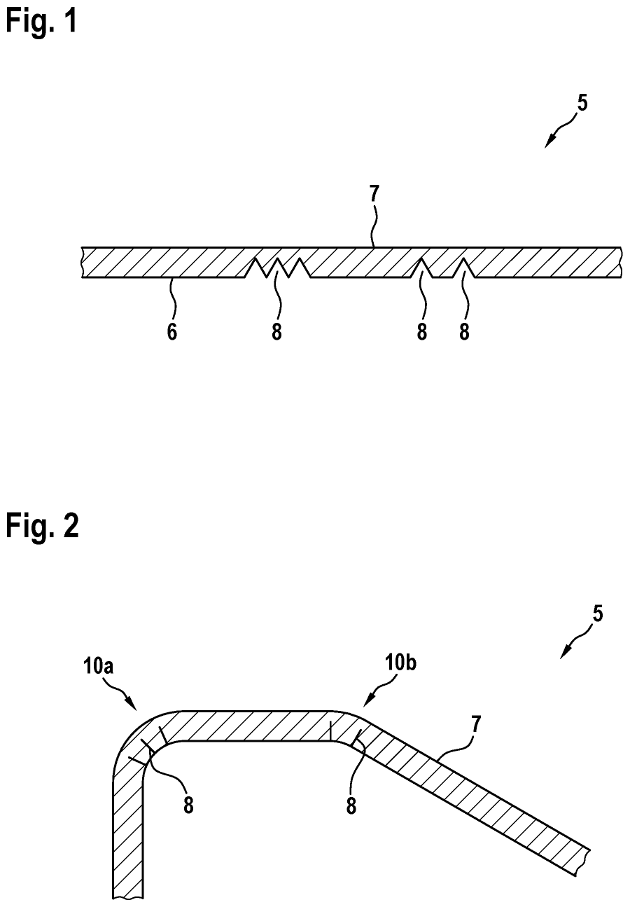

FIG. 1 shows a first variation of a layer of natural fibrous material 5 for a vehicle body component 1 in a rolled out and non-curved state. The layer of natural fibrous material 5 comprises in a first face 6 multiple first notches 8 extending in a first direction and parallel with respect to each other. Also only one first notch 8 may be present. Each first notch 8 has a first depth which is less than the thickness of the at least one layer of natural fibrous material 5. In FIG. 2 a curved state of the layer of natural fibrous material 5 can be seen. The shown layer of natural fibrous material 5 thereby comprises a curved section 10 (here two exemplary curved sections 10a and 10b), wherein the first notches 8 are arranged in said curved sections. Thus a density of the multiple first notches 8 correlates of the curvature of the curved section 10, such that more first notches 8 are arranged in an area with a higher curvature. The curved section 10a having the higher curvature has thus three first notches 8, meanwhile the curved section 10b has only two first notches 8. Furthermore, it can be seen that the respective cross-sections of the first notches 8 are at least partially reduced due to a curvature of the curved section 10. In the FIG. 2 the cross sections are reduced to zero, however also applications are possible where the cross-sections are only at least partially reduced. If the layer of natural fibrous material 5 would be curved in the other direction, it is also possible that the cross-section of first notches 8 are at least partially expanded due to a curvature of the curved section 10.

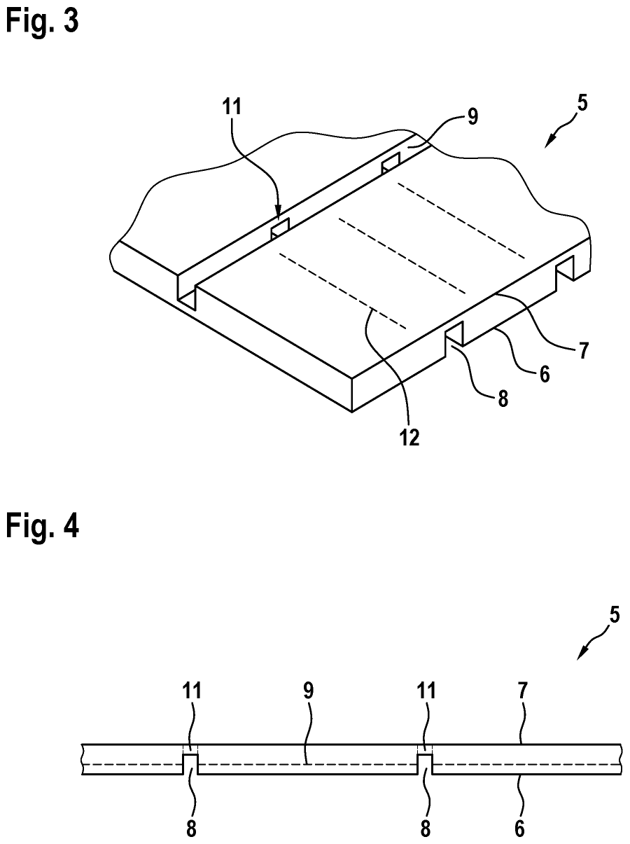

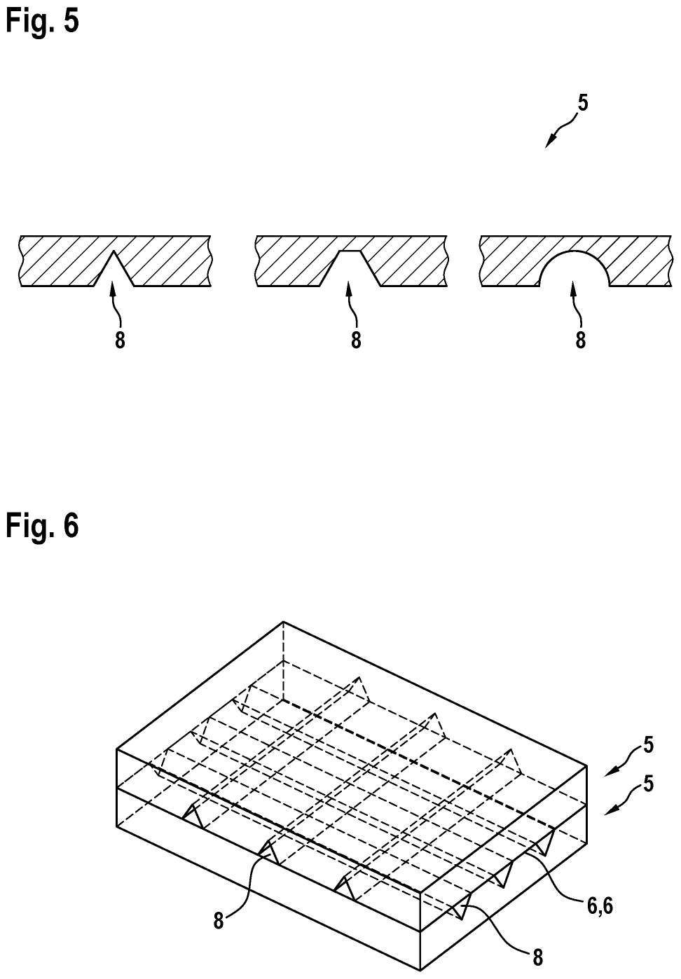

FIG. 3 and FIG. 4 show a second variation of a layer of natural fibrous material 5 for a vehicle body component 1 in a rolled and non-curved state. The shown variation of the layer of natural fibrous material 5 additionally comprises at least one second notch 9 arranged on a second face 7 opposite of the first face 6 comprising the first notches 8. As indicated in FIG. 4, the first and the second notches 8, 9 each have a depth of 60%-80% of the thickness of layer of natural fibrous material 5. Since the second notches 9 extend in a second direction perpendicular to the first direction, the first notches 8 and the second notches 9 intersect each other such that at least one opening 11 extending through the layer of natural fibrous material 5 is formed at the intersection. The layer of natural fibrous material 5 may be wooden veneer comprising wooden fibers 12 having a general fiber direction arranged in the first direction, as indicated in FIG. 3. The cross sections of the first and/or second notches 8,9 may each have different cross sections, as shown in FIG. 5. The cross sections can be among others circular, trapezoidal, rectangular or triangular.

FIG. 6 shows two layers of natural fibrous material 5 for a vehicle body component 1. Both layers have multiple first notches 8 on a first face 6. In the shown arrangement, the individual first faces 6 are arranged to face each other, such that a matrix of notches 8 is formed interconnecting the notches 8 to each other. Other arrangements or number of layers are also possible.

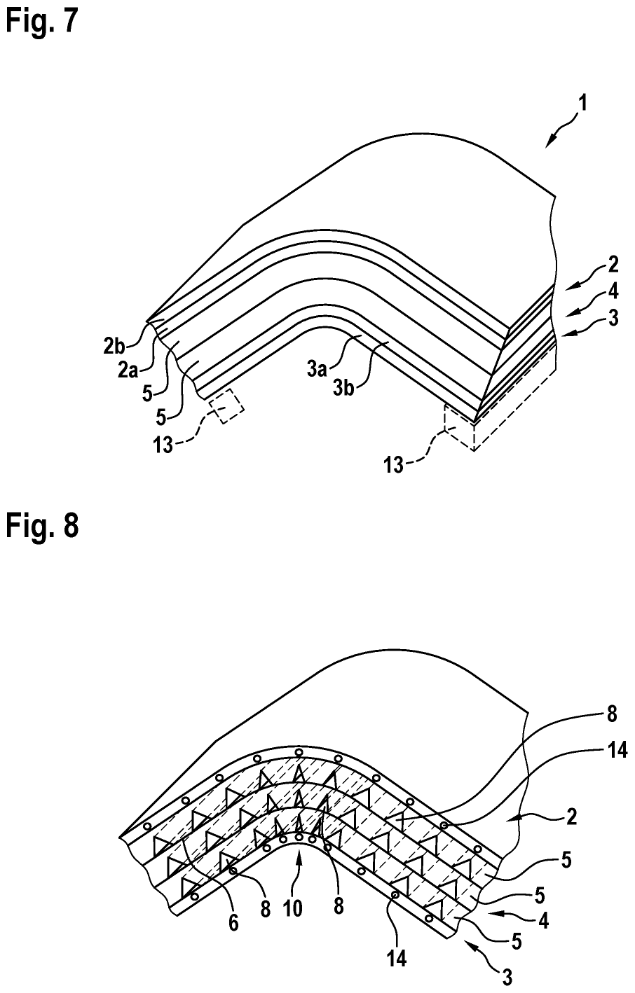

The variations of the layer of natural fibers 5 comprising the notches, as illustrated in FIGS. 1 to 6 are suited for a vehicle body component 1 comprising a top sheet 2, a bottom sheet 3 and a there between arranged core 4 mechanically interconnecting the top sheet 2 and the bottom sheet 3. Such a vehicle body component 1 is shown generically in FIG. 7, wherein the top sheet 2, the bottom sheet 3 and the core 4 can each comprise one or multiple layers. In the shown example the top sheet 2 comprises two layer 2a, b2, the bottom sheet 3 comprises two layers 3a,3b and the core comprises two layers. Thereby, the top sheet 2 and/or the bottom sheet 3 and/or the core 4 may comprise at least one layer of natural fibrous material 5, as explained above. The vehicle body component 1 may further comprise a frame 13 for interconnecting the vehicle body component 1 to a vehicle chassis, as schematically indicated. The frame 13 is preferably interconnected, in particular glued, to the bottom sheet 3.

One variation of such a vehicle body component 1 is shown in FIG. 8 with a top sheet 2, a bottom sheet 3 and a core 4 comprising three layers of natural fibrous material 5. Each layer has multiple first notches 8 on the respective first faces 6 of said layers. All first faces 6 are arranged facing towards the bottom sheet 3. The top sheet 2 and a bottom sheet 3 may be made of reinforcing fibers 14.

Rather, the words used in the specification are words of description rather than limitation, and it is understood that various changes may be made without departing from the scope of the invention.

### LIST OF DESIGNATIONS

1 Vehicle body component
2 Top sheet
3 Bottom sheet
4 Core
5 Layer of natural fibrous material
6 First face
7 Second face
8 First notch
9 Second notch
10 Curved section
11 Opening
12 Wooden fibers
13 Frame
14 Reinforcing fibers

1. A vehicle body component comprising:
a. a top sheet, a bottom sheet and a there between arranged core mechanically interconnecting the top sheet and the bottom sheet;
b. wherein the top sheet and/or the bottom sheet and/or the core comprise at least one layer of natural fibrous material having a thickness;
c. the at least one layer of natural fibrous material comprising in a first face at least one first notch extending in a first direction, the at least one first notch having a first depth which is less than the thickness of the at least one layer of natural fibrous material.

2. The vehicle body component according to claim 1, wherein the vehicle body component comprises a curved section curving around the first direction and wherein the at least one first notch is arranged in the curved section.

3. The vehicle body component according to claim 2, wherein the cross-section of the at least one first notch is at least partially reduced or extended due to a curvature of the curved section.

4. The vehicle body component according to claim 2, wherein the at least one layer of natural fibrous material comprises multiple first notches extending parallel with respect to each other and being arranged in the curved section.

5. The vehicle body component according to claim 4, wherein a density of the multiple first notches correlates of the curvature of the curved section, such that more first notches are arranged in an area with a higher curvature.

6. The vehicle body component according to claim 1, wherein the at least one layer of natural fibrous material comprises at least one second notch having a second depth and being arranged in a second face opposite to the first face of the at least one layer of natural fibrous material.

7. The vehicle body component according to claim 6, wherein the at least one second notch extends in the first or a second direction, perpendicular to the first direction.

8. The vehicle body component according to claim 6, wherein the first depth and/or the second depth is at least 60%, in particular 80%, of the thickness of the at least one layer of natural fibrous material.

9. The vehicle body component according to claim 7, wherein the at least one first notch and the at least one second notch intersect each other and the first depth and the second depth are configured such that at least one opening extends through the at least one layer of natural fibrous material at the intersection.

10. The vehicle body component according to claim 1, wherein the at least one layer of natural fibrous material is made of a wooden veneer.

11. The vehicle body component according to claim 10, wherein the wooden veneer comprises wooden fibers having a general fiber direction arranged in the first direction.

12. The vehicle body component according to claim 1, wherein the vehicle body component comprises a frame for interconnecting the vehicle body component to a vehicle chassis and wherein the frame is interconnected, in particular glued, to the bottom sheet.

13. The vehicle body component according to claim 1, wherein at least one layer of natural fibrous material is arranged in the core of the vehicle body component.

14. The vehicle body component according to claim 13, wherein the core comprises at least two layers of natural fibrous material glued together in a curved manner.

15. The vehicle body component according to claim 14, wherein the at least two layers of natural fibrous material have at least one first notch and/or at least one second notch, such that a three dimensional matrix of notches is formed through the core.

16. The vehicle body component according claim 13, wherein the top sheet and/or the bottom sheet is made of reinforcing fibers.

17. The vehicle body component according to claim 1, wherein at least one layer of natural fibrous material is arranged in the top sheet and/or at least one layer of natural fibrous material is arranged in the bottom sheet of the vehicle body component.

18. The vehicle body component according to claim 1, wherein the at least one layer of natural fibrous material in a non-curved state comprises a wedge shaped cutout extending from an outer edge into the at least one layer of the natural fibrous material in the second direction with a first and thereto opposite second wedge surface configured to be interconnected with each other in order to form a curvature.

19. The vehicle body component according to claim 1, wherein the vehicle body component is a roof element or an engine hood of the vehicle.
